(19) United States
(12) Patent Application Publication
(10) Pub. No.: US 2026/0301045 A1
(43) Pub. Date: Oct. 1, 2026

(54) RECOMMENDATION DIVERSITY EVALUATION

(71) Applicants: Beijing Youzhuju Network Technology Co., Ltd., Pinggu District, Beijing (CN); Lemon Inc., Grand Cayman (KY)

(72) Inventors: Tao Lin, Beijing (CN); Kun Jin, Culver City, CA (US); Andrew Estornell, Los Angeles, CA (US); Xiaoying Zhang, Beijing (CN); Yang Liu, Los Angeles, CA (US)

(21) Appl. No.: 19/101,520

(22) PCT Filed: Apr. 3, 2024
(86) PCT No.: PCT/CN2024/086025

§ 371 Date: Feb. 5, 2025

(51) Int. Cl. G06Q 30/0601

(52) U.S. Cl. CPC G06Q 30/0631

(57) ABSTRACT

The disclosure is related to a method for recommendation diversity evaluation. In the method, a plurality of objects to be recommended in a recommendation system at a first time and a plurality of users to which one or more objects of the plurality of objects is to be recommended at the first time are determined. An object includes a content item or a content creator. State features of the recommendation system at the first time are generated. The state features include at least one of respective content features of the plurality of objects or respective user features of the plurality of users. A diversity metric of the recommendation system at the first time is determined based on the state features. The diversity metric indicates a diversity of the recommendation system in user preferences and content creation.

### FIELD

The present disclosure generally relates to the field of computer, and more specifically, to methods, devices, and computer program products for recommendation diversity evaluation.

### BACKGROUND

From restaurant selection, video watching, to apartment renting, recommendation systems (also referred to as recommender systems) play a pivotal role across a plurality of real-world domains. These systems help users find items (food, videos, etc.) that best match their preferences, while also helping creators (those producing the items) identify their target audiences. Nevertheless, behind such success, concerns have emerged regarding the possible harmful outcomes of recommendation systems, in particular, filter bubbles and polarization, which are typical negative outcomes with insufficient recommendation diversity and creation diversity.

### SUMMARY

In a first aspect of the present disclosure, there is provided a method of recommendation diversity evaluation. The method includes: determining a plurality of objects to be recommended in a recommendation system at a first time and a plurality of users to which one or more objects of the plurality of objects is to be recommended at the first time, an object comprising a content item or a content creator; generating state features of the recommendation system at the first time, the state features comprising at least one of respective content features of the plurality of objects or respective user features of the plurality of users; and determining a diversity metric of the recommendation system at the first time based on the state features, the diversity metric indicating a diversity of the recommendation system in user preferences and content creation.

In a second aspect of the present disclosure, there is provided an electronic device. The electronic device comprises: a computer processor coupled to a computer-readable memory unit, the memory unit comprising instructions that when executed by the computer processor implements a method according to the first aspect of the present disclosure.

In a third aspect of the present disclosure, there is provided a computer program product, the computer program product comprising a computer readable storage medium having program instructions embodied therewith, the program instructions executable by an electronic device to cause the electronic device to perform a method according to the first aspect of the present disclosure.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the more detailed description of some embodiments of the present disclosure in the accompanying drawings, the above and other objects, features, and advantages of the present disclosure will become more apparent, wherein the same reference generally refers to the same components in the embodiments of the present disclosure.

FIG. 1 illustrates an example environment in which example embodiments of the present disclosure can be implemented;

FIG. 2 illustrates an example flowchart of a method of recommendation diversity evaluation according to some embodiments of the present disclosure;

FIG. 3 illustrates an example of generating state features of a recommendation system with models according to some embodiments of the present disclosure; and

FIG. 4 illustrates a block diagram of an electronic device in which various embodiments of the present disclosure can be implemented.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment”, “an embodiment”, “an example embodiment”, and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below. In the following description and claims, unless defined otherwise, all technical and scientific terms used herein have the same meaning as commonly understood by one of ordinary skills in the art to which this disclosure belongs.

It may be understood that data involved in the present technical solution (including but not limited to the data itself, the acquisition or use of the data) should comply with requirements of corresponding laws and regulations and relevant rules.

It may be understood that, before using the technical solutions disclosed in various embodiment of the present disclosure, the user should be informed of the type, scope of use, and use scenario of the information involved in the present disclosure in an appropriate manner in accordance with relevant laws and regulations, and the user's authorization should be obtained.

For example, in response to receiving an active request from the user, prompt information is sent to the user to explicitly inform the user that the requested operation will need to acquire and use the user's information. Therefore, the user may independently choose, according to the prompt information, whether to provide the information to software or hardware such as electronic devices, applications, servers, or storage media that perform operations of the technical solutions of the present disclosure.

As an optional but non-limiting implementation, in response to receiving an active request from the user, the way of sending prompt information to the user, for example, may include a pop-up window, and the prompt information may be presented in the form of text in the pop-up window. In addition, the pop-up window may also carry a selection control for the user to choose “agree” or “disagree” to provide the information to the electronic device.

It may be understood that the above process of notifying and obtaining the user authorization is only illustrative and does not limit the implementation of the present disclosure. Other methods that satisfy relevant laws and regulations are also applicable to the implementation of the present disclosure.

As used herein, the term “model” is referred to as an association between an input and an output learned from training data, and thus a corresponding output may be generated for a given input after the training. The generation of the model may be based on a machine learning technique. In general, a machine learning model may be built, which receives input information and makes predictions based on the input information. For example, a classification model may predict a class of the input information among a predetermined set of classes. As used herein, “model” may also be referred to as “machine learning model”, “learning model”, “machine learning network”, or “learning network,” which are used interchangeably herein.

### Example Environment

FIG. 1 illustrates a block diagram of an example environment 100 in which various embodiments of the present disclosure may be implemented. In the environment 100 of FIG. 1, a recommendation system 120, a plurality of objects 101 and a plurality of users 102 are involved. The recommendation system 120 is configured to recommend one or more of the plurality of objects 101 to each of the plurality of users 102. One or more recommendation policies 110 may be used by the recommendation system 120 for recommendation. The one or more recommendation policies 110 may be collectively or individually referred to as a recommendation policy 110. Objects of the plurality of objects 101 may be collectively or individually referred to as an object 101. An object may include a content item to be recommended, for example, a video, one or more images, a blog, etc. Alternatively, or in addition, the object may include a content creator, for example, an account in a social network application. Users of the plurality of users 102 may be collectively or individually referred to as a user 102.

The recommendation system 120 may be configured to recommend at least part of the plurality of objects 101 to one or more users 102. As an example, the recommendation system 120 may be on a video streaming platform where movies or TV shows may be recommend based on viewing history, ratings, and preferences of a user 102. This recommendation system 120 may include algorithms and rules that determine which content is most suitable for each user, in order to provide a personalized recommendation experience.

Recommendation diversity, meaning the diversity of the contents recommended to a user, is key to users' engagement and retention on the platform. Meanwhile, creation diversity, meaning the variety of content created on the platform, is a determinant of the platform's long-term health.

In extreme cases, insufficient creation diversity can lead to consensus or polarization, where the latter can cause conflict and hatred, diminish people's mutual understanding, and create catastrophic societal crises. Therefore, from both the business and the social responsibility perspectives, championing and improving diversity in recommendation systems is equally important as optimizing recommendation relevance.

There is increasing emphasis in academia and industry on the investigation, and improvement, of diversity within recommendation systems, combating filter bubbles and polarization. Popular diversity-boosting approaches include the application of post-processing procedures such as re-ranking and setting diversity-aware objectives in addition to relevance maximization. These methods aim to increase the recommendation diversity for users. Assuming that the contents on the platform are static, these methods have been demonstrated to reduce the filter bubble effect and bring diversity gain to the system.

However, an important aspect which is overlooked in the aforementioned approaches is that: users and contents on a recommendation platform are not static entities-they can be influenced by the recommendation made by the system. In content creation platforms, recommendations naturally affect both content users and content creators. It is well known that the exposure to recommended items can shift a user's preference. Moreover, the creators also have the incentives to change their creation styles constantly to attract their audience better (also to make more profits from the platform). The dual influence of recommendation on users and creators creates complicated dynamics where users and creators interact, and their preferences evolve. Such evolution might exacerbate the filter bubble and polarization effects.

In view of the above, recommendation diversity is an important attribute of a recommendation system. Therefore, it is expected to provide a solution for recommendation diversity evaluation, in order to monitor a recommendation diversity of the recommendation system or test the recommendation system for recommendation diversity.

Embodiments of the present disclosure propose solutions for recommendation diversity evaluation. According to embodiments of the present disclosure, a plurality of objects to be recommended in a recommendation system at a first time and a plurality of users to which one or more objects of the plurality of objects is to be recommended at the first time are determined. An object comprises a content item or a content creator. State features of the recommendation system at the first time are generated. The state features comprise at least one of respective content features of the plurality of objects or respective user features of the plurality of users. A diversity metric of the recommendation system at the first time is determined based on the state features. The diversity metric indicates a diversity of the recommendation system in user preferences and content creation.

In some embodiments, the recommendation diversity evaluation may be used to monitor a recommendation system in actual operations. As such, a decision can be made timely in absence of recommendation diversity. In some embodiments, the recommendation diversity evaluation may be used to simulate a diversity progress of a recommendation system. As such, diversity of the recommendation system can be tested before actual operations.

In this way, it is possible to building healthy and sustainable recommendation systems, thereby improving the long-term diversity of recommendation systems.

To better understand the example embodiments of the present disclosure, theoretical foundation of the present disclosure will be described in detail below with reference to the accompanying drawings. In the examples of the theoretical foundation, “creator” is used as an example of the object to be recommended. However, it is to be understood that the theoretical foundation is also applicable to other types of objects to be recommended, for example, content items.

A dynamics model is defined for user preferences and content/creator features in a recommendation system. Let

$${U}^{t} = {[ {u}_{j}^{t} ]}_{j = 1}^{m} = [ {u}_{1}^{t} , … , {u}_{m}^{t} ] ∈ \text{?}$$

be a population of m users and

$${V}^{t} = {[ {v}_{i}^{t} ]}_{i = 1}^{n} = [ {v}_{1}^{t} , … , {v}_{n}^{t} ] ∈ \text{?}$$

be a population of n creators at time t, where each vector

$${u}_{j}^{t} , {v}_{i}^{t} ∈ \text{?}$$

represent the preference/feature vector of each user and creator respectively, assumed to be on the unit sphere [symbol] with [symbol] -norm. Then (U^{t}, V^{t}) denotes the state of the dynamics at time t. The dynamics evolve as follows at each time step t≥0.

For recommendation, each user j∈[m] is recommended a creator, where creator i∈[n] is chosen with a probability:

$${p}_{ij}^{t} = {p}_{ij}^{t} ( {U}^{t} , {V}^{t} ) . \qquad ( 1 )$$

While a wide array of different

$${p}_{ij}^{t}$$

is studied, a common example of such functions is the so-called softmax function:

$${p}_{ij}^{t} = softmax ( {u}_{j}^{t} , {V}^{t} ; β ) = \frac{exp ( β ( {u}_{j}^{t} , {v}_{i}^{t} ) )}{{\sum }_{i = 1}^{n} exp ( β ( {u}_{j}^{t} , {v}_{i}^{t} ) )} , \qquad ( 2 )$$

where a larger β means that the recommendation is more sensitive to relevance, measured by

$$〈 {u}_{j}^{t} , {v}_{i}^{t} 〉 .$$

For user update, after recommendation, each user j∈[m] updates their feature vector

$${u}_{j}^{t} ,$$

based on which creator, say

$${i}_{j}^{t}$$

was recommended to them.

$${u}_{j}^{t + 1} = 𝒫 ( {u}_{j}^{t} + {η}_{u} f ( {v}_{{i}_{j}^{t}}^{t} , {u}_{j}^{t} ) {v}_{{i}_{j}^{t}}^{t} ) \qquad ( 3 )$$

where ηᵤ∈[0,1] is a parameter controlling the rate of update, f(vᵢ, uⱼ) is a function that quantifies the impact of creator i's content on user j (discussed in detail later), and

$$𝒫 ( x ) = \frac{x}{{‖ x ‖}_{2}}$$

is the projection back onto the unit sphere.

For creator update, creators also update their feature vectors based on which users are recommended their content. For each creator i∈[n], let

$${J}_{i}^{t} = \{ j : {i}_{j}^{t} = i \}$$

be the set of users being recommended creator i, then

$${v}_{i}^{t}$$

is updated by:

$${v}_{i}^{t + 1} = 𝒫 ( {v}_{i}^{t} + \frac{{η}_{c}}{\vert {J}_{i}^{t} \vert} {\sum }_{j ∈ {J}_{i}^{t}} g ( {u}_{j}^{t} , {v}_{i}^{t} ) {u}_{j}^{t} ) \qquad ( 4 )$$

where η_{c}∈[0,1] is a parameter controlling the rate of update, and g(uⱼ, vᵢ) (discussed next) is a function that quantifies the impact of user j on creator i.

The results apply to any impact functions f and g which satisfy the following natural assumptions. First, assume f(vᵢ, uⱼ) and the inner product [symbol] vᵢ, uⱼ [symbol] have the same sign:

$$f ( {v}_{i} , {u}_{j} ) is \{ \begin{matrix}> 0 & if 〈 {v}_{i} , {u}_{j} 〉 > 0 \\ < 0 & if 〈 {v}_{i} , {u}_{j} 〉 < 0 \\ = 0 & if 〈 {v}_{i} , {u}_{j} 〉 = 0\end{matrix} . \qquad ( 5 )$$

This means that if a user likes the content

$$( 〈 {u}_{i}^{t} , {u}_{j}^{t} 〉 > 0 ) ,$$

then the user vector

$${u}_{j}^{t}$$

will be updated towards the direction of the creator vector

$${v}_{j}^{t} .$$

If the user dislikes the content

$$( 〈 {v}_{i}^{t} , {u}_{j}^{t} 〉 < 0 ) ,$$

then the user vector

$${u}_{j}^{t}$$

will move away from

$${v}_{j}^{t} .$$

Further assume upper and lower bounds on |f|:

$$\vert f ( {v}_{i} , {u}_{j} ) \vert \leq 1 ,$$

$$\vert f ( {v}_{i} , {u}_{j} ) \vert \geq {L}_{f} > 0 whenever 〈 {v}_{i} , {u}_{j} 〉 \neq 0.$$

The lower bound |f(vᵢ, uⱼ)|≥L_{f} means that the exposure to an item that a user likes or dislikes always has some non-negligible impact on the user's preference. The example f(vᵢ, uⱼ)=sign( [symbol] vᵢ, uⱼ [symbol] )a+b [symbol] vᵢ, uⱼ [symbol] satisfies both assumptions when L_{f}=a>0 and b≥0. For g, likewise assume that its sign is the same as [symbol] uⱼ, vᵢ [symbol] :

$$g ( {u}_{j} , {v}_{i} ) is \{ \begin{matrix}> 0 & if 〈 {u}_{j} , {v}_{i} 〉 > 0 \\ < 0 & if 〈 {u}_{j} , {v}_{i} 〉 < 0 \\ = 0 & if 〈 {u}_{j} , {v}_{i} 〉 = 0\end{matrix} . \qquad ( 6 )$$

Intuitively, this captures the incentive of a creator who tries to maximize the average ratings from users who are recommended their items. On video platforms for example, if the creators are rewarded based on the average rating of their videos, they will try to reinforce their creation style based on the users who give positive feedback ( [symbol] uⱼ, vᵢ [symbol] =0) so that their creations are more likely to be recommended to those positive-feedback users. Meanwhile, they will also change their creation style based on negative feedback ( [symbol] uⱼ, vᵢ [symbol] <0), but in the opposite direction of the negative-feedback users' interests, so that their creations are less likely to be recommended to those users.

A particular example of (is the sign function g(uⱼ, vᵢ)=sign( [symbol] uⱼ, vᵢ [symbol] )∈{−1, 0, 1}. The sign function is considered only in the Theorem as shown in Table 1 in order to simplify the theoretical analysis. All the other results hold for general g functions.

Having defined the user-creator feature dynamics in a recommendation system with dual influence, how such dynamics evolve is now theoretically studied. The main result is: if every creator always has a non-zero probability of being recommended to every user, then such dynamics must eventually fall into polarization.

Let R>0. The dynamics (U^{t}, V^{t}) is said to reach: R-consensus if there exists a vector c∈ [symbol] such that every feature vector is R-close to

$$c : ∀ {u}_{j}^{t} , {‖ {u}_{j}^{t} - c ‖}_{2} \leq R and ∀ {v}_{i}^{t} , {‖ {v}_{i}^{t} - c ‖}_{2} \leq R ;$$

and R-bi-polarization if there exists a vector c∈ [symbol] such that every feature vector is R-close to

$$+ c or - c : ∀ {u}_{j}^{t} , {‖ {u}_{j}^{t} - c ‖}_{2} \leq R or {‖ {u}_{j}^{t} + c ‖}_{2} \leq R$$

holds, and

$$∀ {v}_{i}^{t} , {‖ {v}_{i}^{t} - c ‖}_{2} \leq R or {‖ {v}_{i}^{t} + c ‖}_{2} \leq R$$

holds.

The dynamics is said to reach (R, c)-consensus (or (R, c)-bi-polarization) if the dynamics reaches R-consensus (or R-bi-polarization) with the vector c.

Consensus is any state where all users and creators have similar feature vectors (with maximum difference R), implying that they have similar interests or preferences. Bi-polarization is any state where all users and creators are clustered into two groups with exactly opposite features (e.g., Republicans vs Democrats). Mathematically, consensus is a special case of bi-polarization.

Bi-polarization states are absorbing. Once the dynamics reaches (R, c)-bi-polarization with some R∈[0,1] and c∈ [symbol] , it will satisfy (R, c)-bi-polarization forever. The same holds for consensus.

A natural condition on the recommendation probability of a recommendation system is

$${p}_{ij}^{t} \geq {p}_{0} > 0 , ∀ i , j , t ,$$

with some lower bound p₀, namely, every creator is possible to be recommended to every user with some non-zero probability. In particular, this is satisfied by the softmax probability function, which is a rough model of real-world recommendation algorithms:

$${p}_{ij}^{t} = \frac{exp ( β 〈 {u}_{j}^{t} , {v}_{i}^{t} 〉 )}{{\sum }_{i = 1}^{n} exp ( β 〈 {u}_{j}^{t} , {v}_{i}^{t} 〉 )} \geq \frac{exp ( - β )}{n exp ( β )} = {p}_{0} > 0. \qquad ( 7 )$$

Imposing

$${p}_{ij}^{t} \geq {p}_{0} > 0$$

artificially is also a natural attempt to increase the diversity of the contents recommended to users. However, a recommendation system satisfying

$${p}_{ij}^{t} \geq {p}_{0} > 0$$

must converge to polarization.

TABLE 1
Theorem: Suppose g(uⱼ, vᵢ) = sign( [symbol] uⱼ, vᵢ [symbol] ) update rates
${η}_{c} \leq \frac{{η}_{u} {L}_{f}}{2} and {η}_{u} < \frac{1}{2} , and the recommendation probablity$
${p}_{ii}^{t} \geq {p}_{0} > 0 , ∀ i , j , t . Then , for almost all initial states , the dynamics$
(U^{t}, V^{t}) must eventually reach R-consensus or R-bi-polarization for any R > 0.

Before giving a proof sketch of the Theorem as shown in Table 1, two remarks may be made. First, the Theorem guarantees that the dynamics will polarize to at most two clusters regardless of the dimension d of features vectors. Second, since creators in one cluster produce similar contents, users in a polarized system can never receive diverse recommendations. This means that the naive attempt of increasing recommendation diversity for users by imposing

$${p}_{ij}^{t} \geq {p}_{0}$$

does not work.

The proof of Theorem as shown in Table 1 uses a lemma as shown in Table 2.

TABLE 2
$Lemma : Suppose {η}_{c} \leq \frac{{η}_{u} {L}_{f}}{2} and {η}_{u} < \frac{1}{2} . For any R > 0 , for$
almost every state (U^{t}, V^{t}) in the state space, there exists a path
(U^{t}, V^{t}) [symbol] (U^{t+1,} V^{t+1}) [symbol] ... [symbol] (U^{t+T}, V^{t+T})
of finite length that leads to an R-bi- polarization state (U^{t+T}, V^{t+T}).

The proof of this lemma is involved. It uses induction on the number of creators n. The base case of n=1 is proved by a potential function argument. For n≥2, path is constructed first that leads the subsystem of n−1 creators and all users to R-bi-polarization. Then, depending on where the remaining creator is, a sequence of recommendations is constructed that leads the remaining creator to one of the two clusters formed by the n−1 creators and all users. Such recommendations will move some users out of the formed clusters however, which requires extra care in the proof.

To prove the Theorem as shown in Table 1, for any state (U^{t}. V^{t}) in the space, by the Lemma shown in Table 2 there exists a path state (U^{t}, V^{t}) [symbol] . . . [symbol] (U^{t+T}, V^{t+T}) of length T that leads to R-bi-polarization. Because every creator can be recommended to a user with probability at least po, each transition (U^{t′}, V^{t′}) [symbol] (U^{t′+1}, V^{t′+1}) happens with probability at least

$${p}_{0}^{m} .$$

So, the path of length T has probability at least

$${p}_{0}^{mT} > 0 ,$$

and the probability that the dynamics does not reach R-bi-polarization after KT steps is at most:

$${( 1 - {p}_{0}^{mT} )}^{K} \to 0 \qquad ( 8 )$$

as K [symbol] 0. Therefore, with probability 1 the dynamics will reach R-bi-polarization eventually.

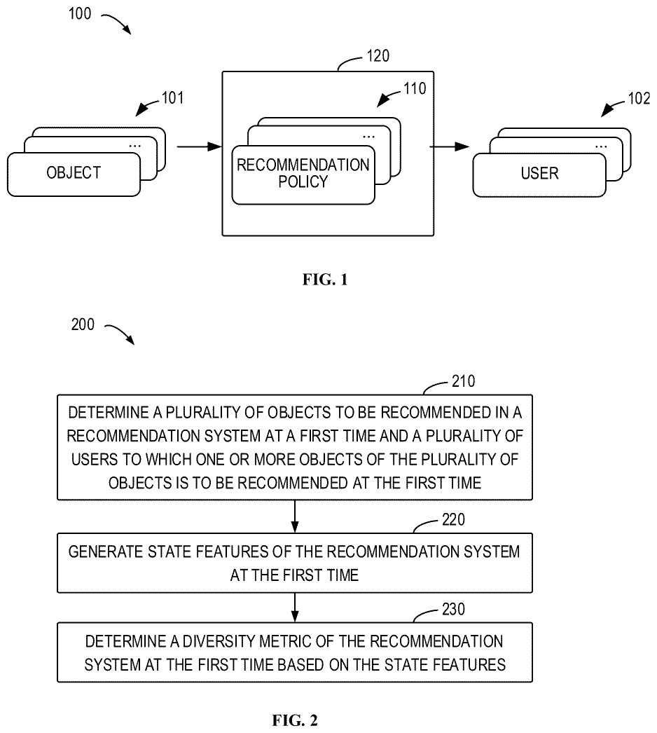

Reference now is made to FIG. 2, which illustrates an example flowchart of a method 200 of recommendation diversity evaluation according to some embodiments of the present disclosure.

At a block 210, a plurality of objects to be recommended in a recommendation system at a first time and a plurality of users to which one or more objects of the plurality of objects is to be recommended at the first time are determined. An object comprises a content item or a content creator. To simulate or analyze the diversity of the recommendation system over time, a time parameter, i.e., the first time, is introduced. For example, by analyzing the diversity of a recommendation system on the first day and then analyzing the diversity of this system again after 10 days, the relationship of the diversity of the recommendation system over time may be observed. It will be described in detail below. The first time may be of any suitable granularity, and may be considered as any of time steps for evaluating the diversity of the recommendation system.

At a block 220, state features of the recommendation system at the first time are generated. The state features comprise at least one of respective content features of the plurality of objects or respective user features of the plurality of users. For example, the state features may be represented as (U^{t}, V^{t}), where U^{t} represents user features at a time t and V^{t} represents content features at the time t.

In some embodiments, recommendation diversity evaluation may be used to monitor a recommendation system in actual operations. In these embodiments, to generate state features of the recommendation system at the first time, for a given user of the plurality of users, a user feature of the given user may be generated based on information about the given user, to obtain the respective user features of the plurality of users. Alternatively, or in addition, for a given object of the plurality of objects, a content feature of the given object may be generated based on information about the given object, to obtain the respective content features of the plurality of objects.

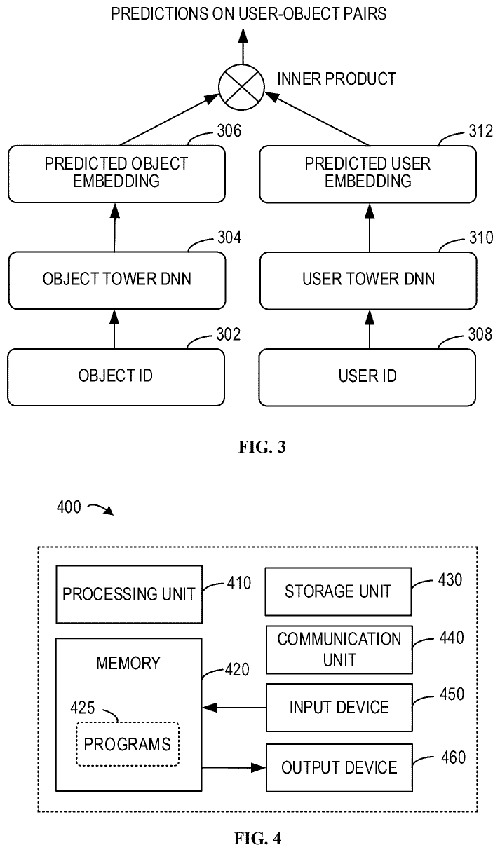

FIG. 3 illustrates an example of generating state features of a recommendation system with models according to some embodiments of the present disclosure. Two tower models, e.g., Deep Neural Network (DNN) may be used, including an object tower DNN 304 and a user tower DNN 310. The two tower models both have size 16× 16 with linear layers and ReLu activations.

Specifically, an object ID 302 which indicating information about a given object may be input to the object tower DNN 304, and a user ID 308 which indicating information about a given user may be input to the user tower DNN 310. Then the two tower models output a predicted object embedding vector 306 and a predicted user embedding vector 312, respectively. That is, the predicted object embedding vector 306 represents a content feature of the given object and the predicted user embedding vector 312 represents a user feature of the given user. The inner product may be performed on these two vectors to obtain predictions on user-object pairs. The procedure may be repeated to obtain state features of a recommendation system. In this way, a recommendation system may be monitored in actual operations.

In some embodiments, the recommendation diversity evaluation may be used to simulate a diversity progress of a recommendation system. In these embodiments, to generate state features of the recommendation system at the first time, for a given user of the plurality of users, a user feature of the given user at a second time may be updated based on objects recommended to the given user at the second time, so as to obtain the respective user features of the plurality of users. The second time is previous to the first time. Alternatively, or in addition, for a given object of the plurality of objects, a content feature of the given object at the second time may be updated based on users to which the given object is recommended, so as to obtain the respective content features of the plurality of objects. That is, a user feature of a user is updated according to objects recommended to that user historically, and a content feature of an object is updated according to users to which the object is recommended historically.

As described above, the equation (3) may be used to update user feature vector of the given user based on which object is recommended to the user. The equation (4) may be used to update a content feature vector of the given object based on which user is recommended the corresponding content.

Continuing with the method 200, at a block 230, a diversity metric of the recommendation system at the first time is determined based on the state features. The diversity metric indicates a diversity of the recommendation system in user preferences and content creation.

In summary, a novel, natural model that captures the dual influence of a recommendation system on users and objects is defined. The users' and object's embedding vectors may be used to represent their preferences and creation styles. With this model, it is allowed to formally reason about the impact of various design choices on the diversity of a recommendation system with dual influence.

In some embodiments, to determine a diversity metric of the recommendation system, a polarization metric may be determined based on a similarity between each pair of content features of the respective content features. The polarization metric may indicate a degree of the recommendation system approaching a polarized recommendation state.

To quantify the behavior of the dynamics, given a state of user and object feature vectors (U, V), a measurement of polarization of the system may be computed.

For example, a polarization metric may be tendency to polarization (TP) which represents a novel measurement to be proposed to quantify how close the system is to consensus or bi-polarization, measured by the average absolute inner products between objects:

$$TP ( V ) = \frac{1}{{n}^{2}} {\sum }_{i = 1}^{n} {\sum }_{k = 1}^{n} \vert 〈 {v}_{i} , {v}_{k} 〉 \vert \qquad ( 9 )$$

where TP(V) being closer to 1 means that the system is more polarized, because the term | [symbol] vᵢ, vₖ [symbol] | is 1 if the two vectors vᵢ, vₖ are equal or opposite to each other.

In some embodiments, the polarized recommendation state may comprise a consensus state in which objects in the recommendation system are preferred by all users of the recommendation system. For example, a consensus state may be any state where all users and objects have similar feature vectors (with maximum difference R), implying that they have similar interests or preferences.

Alternatively, or in addition, the polarized recommendation state may comprise a bi-polarization state in which objects and users in the recommendation system are divided into two opposite groups with objects in a first group being preferred by users in the first group and objects in a second group being preferred by users in the second group. For example, a bi-polarization state may be any state where all users and objects are clustered into two groups with exactly opposite features (e.g., preferring red color vs preferring green color).

In some embodiments, to determine a diversity metric of the recommendation system, a creation diversity metric may be determined based on a difference between each pair of content features of the respective content features. The creation diversity metric may indicate a degree of diversity in content creation.

For example, three key parameters in a model may be β sensitivity of the softmax function), η_{c} (creator update rate), and ηᵤ (user update rate). They are set to β=1, η_{c}=ηᵤ=0.1, and change one parameter at a time to see its effect on the dynamics.

To quantify the behavior of the dynamics, given a state of user and creator feature vectors (U, V) the measurement of diversity of the system may be computed. For instance, a creation diversity metric may be Creator Diversity (CD) which represents diversity of the creator features, measured by their average pairwise distance:

$$CD ( V ) = \frac{1}{n ( n - 1 )} {\sum }_{i = 1}^{n} {\sum }_{j \neq i} ‖ {v}_{i} - {v}_{j} ‖ . \qquad ( 10 )$$

In some embodiments, to determine a diversity metric of the recommendation system, a recommendation diversity metric may be determined based on a difference between each pair of content features recommended to a user of the plurality of users. The recommendation diversity metric may indicate a degree of diversity of contents recommended to a same user.

For example, a recommendation diversity metric may be Recommendation Diversity (RD) which represents diversity of the contents recommended to a user, measured by the weighted variance of the contents:

$$RD ( U , V ; β ) = \frac{1}{m} {\sum }_{j = 1}^{m} {\sum }_{i = 1}^{n} {p}_{ij} {‖ {v}_{i} - {\overline{v}}_{j} ‖}^{2} \qquad ( 11 )$$

where

$${\overline{v}}_{j} = {\sum }_{i = 1}^{n} {p}_{ij} {v}_{i} and {p}_{ij} = \frac{exp ( β 〈 {u}_{j} , {v}_{i} 〉 )}{{\sum }_{i = 1}^{n} exp ( β 〈 {u}_{j} , {v}_{i} 〉 )} .$$

In some embodiments, to determine a diversity metric of the recommendation system, a recommendation relevance metric may be determined based on a similarity between each content feature of the respective content features and each user feature of the respective user features. In some cases, cosine similarity may be used to characterize the relevance of objects and users' interests.

For example, a recommendation relevance metric may be Recommendation Relevance (RR) which represents relevance of the contents recommended to a user, measured by the weighted average of inner products:

$$RR ( U , V ; β ) = \frac{1}{m} {\sum }_{j = 1}^{m} {\sum }_{i = 1}^{n} {p}_{ij} 〈 {u}_{j} , {v}_{i} 〉 . \qquad ( 12 )$$

It is worth noting that a high creator diversity is necessary for simultaneously achieving high recommendation relevance and high recommendation diversity. For example, they cannot be simultaneously achieved in a polarized state.

For example, a larger sensitivity parameter β means that a user will be recommended more relevant content/creator with a higher probability. β=0, on the other hand, means that the user receives uniform recommendations across all creators. An observation from the experiments is: a larger β leads to higher creator diversity and alleviated polarization in the long run.

In an experiment, under different β values, if a dimension d=3 is chosen instead of 10 so the feature vectors can be visualized on a 3d sphere. The system tends to form more clusters at time t=200 than clusters at time t=100 as β increases.

In another experiment, the changes of the 4 measures CD, RD, RR, TP over time under different β values may be shown. A more diverse recommendation policy (a smaller β) leads to lower creator diversity and a higher level of polarization in the long run. In particular, while CD reaches a similar level under different β in the end, it may drop at a slower rate with a larger β. Moreover, from the plot of TP, a larger β may alleviate polarization, which means improvement in the diversity of the whole system.

As a result, when β is smaller, each user receives more uniform recommendations across all creators, so for different creators the sets of users recommended to those creators have larger intersections. Since the creator updates are based on the sets of recommended users, different creators will be moving towards more similar directions. This leads to faster polarization.

This observation may also be predicted from the Theorem above: when β is large, the minimum recommendation probability p₀ of the softmax function tends to 0, so it might take a long time for the system to converge to polarization, while with a small β the system polarizes quickly.

A larger creator update rate means that creator features are updated faster, and intuitively should lead to faster polarization. This may be validated in experiments: a larger η_{c} indeed causes more extreme polarization and lower diversity (both CD and RD).

A larger user update rate ηᵤ means that user features are updated faster. It has a similar effect of exacerbating polarization as η_{c} does.

In some embodiments, if the recommendation diversity degrades, an action may be made to improve the diversity. For example, if the diversity falls below a diversity threshold, an action to improve the diversity may be taken, or indicated to for example an administrator of the recommendation system. The action may be dependent on a specific recommendation policy used by the recommendation system.

In some embodiments, the recommendation system may be configured to recommend top k objects from the plurality of objects to a user, or in other words top-k recommendation policy is used. In such embodiments, if the diversity metric is below a diversity threshold, a value of k may be decreased or an indication to decrease the value of k may be presented, for example, to a relevant party, such as an administrator of the recommendation system. That is, a Top-k recommendation policy in a recommendation system may affect the user-object feature dynamics.

A prevalent practice in modern two-stage recommendation algorithms on large-scale platforms is to first filter out items that are unlikely to be relevant to a user, then make recommendations from the remaining items. This practice significantly reduces the computation cost and improves the relevancy of recommendations. Such a practice also has the potential to improve the long-term diversity of a recommendation system with dual influence.

In particular, the top-k recommendation policy is considered where each user is recommended only the k most relevant creators, so

$${p}_{ij}^{t} = 0$$

whenever i is not one of k creators i′∈[n] that maximize

$$〈 {v}_{{i}^{′}}^{t} , {u}_{j}^{t} 〉 .$$

A state (U^{t}, V^{t}) forms q clusters if there exist c₁, . . . , c_{q}∈ [symbol] and a small number R>0 such that every feature vector is in the [symbol] ball of some cᵢ with radius R (denoted by B( [symbol] , R)={x: ∥x− [symbol] ∥₂≤R}) and, B( [symbol] , 2R) B( [symbol] , 2R) for [symbol] ≠ [symbol] for do not intersect.

It is clear that consensus has a single cluster, and bi-polarization has two.

With the top-k recommendation, there exist states (U^{t}, V^{t}) that form └n/k┘ clusters and are ab-sorbing (i.e., once the system forms └n/k┘ clusters, it forms └n/k┘ clusters forever).

This result is in contrast with the Theorem mentioned above which shows that a recommendation system where every creator can be recommended to every user

$$( {p}_{ij}^{t} > 0 )$$

is doomed to polarize. With top-k recommendation where some

$${p}_{ij}^{t} = 0 ,$$

polarization can be avoided.

Experiments with top-k recommendation are run with different values of k. Results in Table 3 support the claim that a small k improves the diversity of the recommendation system and reduces polarization.

TABLE 3
Diversity improvement by top-k recommendation

| β | k | CD | RD | RR | TP |
|---|---|---|---|---|---|
| 0 | 50 | 1.00 ± 0.03 | 0.98 ± 0.03 | 0.00 ± 0.02 | 1.00 ± 10⁻³ |
| | 25 | 0.39 ± 0.32 | 0.08 ± 0.10 | 0.87 ± 0.07 | 0.98 ± 0.05 |
| | 20 | 0.77 ± 0.25 | 0.01 ± 0.02 | 0.98 ± 0.03 | 0.73 ± 0.16 |
| | 10 | 1.17 ± 0.06 | 0.00 ± 10⁻³ | 1.00 ± 10⁻³ | 0.48 ± 0.07 |
| | 5 | 1.31 ± 0.01 | 0.00 ± 10⁻³ | 1.00 ± 10⁻³ | 0.36 ± 0.03 |
| | 1 | 1.40 ± 10⁻³ | 0.00 ± 10⁻³ | 1.00 ± 10⁻³ | 0.27 ± 10⁻³ |
| 1 | 50 | 1.00 ± 0.03 | 0.42 ± 0.01 | 0.76 ± 0.01 | 1.00 ± 10⁻³ |
| | 25 | 0.52 ± 0.32 | 0.03 ± 0.03 | 0.97 ± 0.02 | 0.91 ± 0.13 |
| | 20 | 0.91 ± 0.15 | 0.00 ± 0.01 | 1.00 ± 0.01 | 0.68 ± 0.12 |
| | 10 | 1.17 ± 0.06 | 0.00 ± 10⁻³ | 1.00 ± 10⁻³ | 0.50 ± 0.07 |
| | 5 | 1.31 ± 0.02 | 0.00 ± 10⁻³ | 1.00 ± 10⁻³ | 0.35 ± 0.03 |
| | 1 | 1.40 ± 10⁻³ | 0.00 ± 10⁻³ | 1.00 ± 10⁻³ | 0.27 ± 10⁻³ |
| 3 | 50 | 0.95 ± 0.14 | 0.02 ± 0.02 | 0.99 ± 0.01 | 0.91 ± 0.10 |
| | 25 | 0.80 ± 0.24 | 0.00 ± 0.01 | 1.00 ± 10⁻³ | 0.77 ± 0.13 |
| | 20 | 0.89 ± 0.13 | 0.00 ± 10⁻³ | 1.00 ± 10⁻³ | 0.74 ± 0.11 |
| | 10 | 1.18 ± 0.05 | 0.00 ± 10⁻³ | 1.00 ± 10⁻³ | 0.49 ± 0.07 |
| | 5 | 1.31 ± 0.02 | 0.00 ± 10⁻³ | 1.00 ± 10⁻³ | 0.34 ± 0.03 |
| | 1 | 1.40 ± 10⁻³ | 0.00 ± 10⁻³ | 1.00 ± 10⁻³ | 0.27 ± 10⁻³ |

The results suggest a fundamental tradeoff between the diversity of recommendations to users and the diversity of creations in the system. A top-k recommendation policy with small k is “not diverse” for users because it exposes a user only to a small set of contents. However, such a policy can lead to a more diverse outcome in the whole system.

In some embodiments, the recommendation system may be configured to filter, for a target user, objects having similarities with the target user below a similarity threshold. In other words, a truncation policy may be used. In such embodiments, if the diversity metric is below a diversity threshold, a value of the similarity threshold may be increased, or an indication to increase the value of the similarity threshold may be presented, for example, to a relevant party, such as an administrator of the recommendation system.

Besides top-k recommendation, truncation is another way to filter out irrelevant creators: set a threshold [symbol] ∈[−1, 1] such that any user-creator pair with inner product [symbol] uᵢ, vⱼ [symbol] < [symbol] is not recommended. A natural choice is [symbol] =0, meaning that users will not receive recommendations predicted to be “disliked” by them. Increasing is similar to increasing the β in the softmax function, which improves recommendation relevance.

In d-dimensional feature space, if user-creator pairs [symbol] uᵢ, vⱼ [symbol] <0 with are not recommended, then there exist stable states with d+1 clusters.

Although truncation allows stable states with d+1 clusters to exist, it does not mean that the dynamics must converge to such states; the dynamics can still end up with stable states with fewer clusters. In fact, it can be seen from experiments that truncating at [symbol] =0 is not good for diversity and causes severe polarization, while truncating at a large threshold like 0.707 is better for system diversity.

In some embodiments, the recommendation system may be configured to perform recommendation by applying a diversity boosting factor to a diversity reward. The method 200 may further comprise: if it is determined that the diversity metric is below a diversity threshold, the diversity boosting factor may be decreased or an indication to decrease the diversity boosting factor may be presented, for example, to a relevant party, such as an administrator of the recommendation system.

Diversity boosting tries to explore users' interests and improve users' experience. For example, when making recommendations, the model optimizes the following objective:

$${h}_{rel} ( 〈 {u}_{i} , {v}_{j} 〉 ) + ρ {h}_{div} ( {list}_{i} , {v}_{j} ) \qquad ( 13 )$$

where hᵣₑₗ, h_{div} rewards the recommendation relevance and diversity respectively and listᵢ records the recent list of recommended items to user i_{D}. h_{div} can take a simple form of Σ_{j′∈list}_{ᵢ} 1− [symbol] v_{j′}, vⱼ [symbol] , and ρ>0 controls the strength of diversity-boosting. Despite being successful when users' preferences and items are fixed, this recommendation policy alone cannot prevent bi-polarization with the natural dynamics, since the conditions in the Theorem mentioned above are still satisfied and the users' and creators' update rules remain the same.

It can be seen very similar results compared with the synthetic data experiments that myopically promoting the one-shot recommendation diversity results in a higher tendency to polarization and a lower creation diversity in the long run. For example, as ρ increases, the system goes to polarization more quickly.

Moreover, a technique has been suggested as a means of improving diversity in recommendation systems: guaranteeing all recommendation probabilities have a nonzero lower bound. In some real-world recommendation systems, a small fraction of random traffic from all creators is added to each user's recommendation pool; this guarantees the existence of a nonzero lower bound on all recommendation probabilities. While such a technique has been shown to improve diversity in recommendation systems where users and creators are static, the opposite is true when both parties are influenced by the decisions of the system. The Theorem mentioned above directly implies that when the probability for each creator to be recommended to a user has a lower bound p₀>0, the system is guaranteed to polarize. Such an observation is particularly striking as it demonstrates that optimizing for recommendation diversity in a static setting can ultimately result in a huge loss of the system diversity in the long-run.

In summary, how real-world recommendation policy in recommendation systems affect the user-creator feature dynamics have been discussed above. There are four types of recommendation policy: top-k recommendation, truncation, diversity-boosting, and lower-bounding probabilities.

In the above embodiments, actions to improve the diversity are related to the recommendation policy. In some embodiments, one or more actions related to feature representations of the users may be taken. For example, if the diversity metric is below a diversity threshold, feature dimensions of each user feature may be adjusted by increasing a ratio of fixed value dimensions to variable value dimensions. An example of variable value dimension may be a type of video to watch. An example of fixed value dimension may be gender of the user.

For example, a case where some dimensions of the user feature vectors are fixed features and thus not updated from round to round (e.g., ages, genders) may be considered. This is a realistic setting in recommendation systems that make predictions not only based on user-item interaction data. In an experiment, the diversity of the system improves as the number of fixed dimensions increases, and the degree of polarization is reduced. This is similar to the effect of decreasing user update rate ηᵤ described above. The observation that fixed user features encourage diversity might be a reason why the recommendation systems in practice are not as polarized.

In summary, a novel, natural model that captures the dual influence of a recommendation system on users and objects is defined. The users' and object's embedding vectors may be used to represent their preferences and creation styles, and cosine similarity may be used to characterize the relevance of creations and users' interests. With this model, it is allowed to formally reason about the impact of various design choices on the diversity of a recommendation system with dual influence.

Further, it is demonstrated that under realistic conditions, any recommendation system with dual influence on users and creators is guaranteed to converge to polarization, i.e., the preferences of users and the contents of creators will be tightly clustered into two opposite groups (bringing the diversity of the system to nearly zero). Some common efficiency-improving methods, such as two-stage recommendation, can both prevent the system from polarization and improve the creation diversity. As predicted by the theory, systems with dual influence more easily converge to polarization under diversity-boosting designs, while efficiency-oriented and relevance-optimizing designs can in fact improve the long-term diversity of the system.

### Example Process and Device

FIG. 2 illustrates a flowchart of a method 200 of recommendation diversity evaluation in accordance with some example implementations of the present disclosure. The method 200 may be implemented in the environment 100 as illustrated in FIG. 1. At a block 210, a plurality of objects to be recommended in a recommendation system at a first time and a plurality of users to which one or more objects of the plurality of objects is to be recommended at the first time are determined. An object comprises a content item or a content creator. At a block 220, state features of the recommendation system at the first time are generated. The state features comprise at least one of respective content features of the plurality of objects or respective user features of the plurality of users. At a block 230, a diversity metric of the recommendation system at the first time is determined based on the state features. The diversity metric indicates a diversity of the recommendation system in user preferences and content creation.

In some embodiments, determining a diversity metric of the recommendation system at the first time based on at least one of the respective content features or the respective user features comprises: determining a polarization metric based on a similarity between each pair of content features of the respective content features, the polarization metric indicating a degree of the recommendation system approaching a polarized recommendation state.

In some embodiments, the polarized recommendation state comprises at least one of: a consensus state in which objects in the recommendation system are preferred by all users of the recommendation system, or a bi-polarization state in which objects and users in the recommendation system are divided into two opposite groups with objects in a first group being preferred by users in the first group and objects in a second group being preferred by users in the second group.

In some embodiments, determining a diversity metric of the recommendation system at the first time based on at least one of the respective content features or the respective user features further comprises at least one of: determining a creation diversity metric based on a difference between each pair of content features of the respective content features, the creation diversity metric indicating a degree of diversity in content creation, determining a recommendation diversity metric based on a difference between each pair of content features recommended to a user of the plurality of users, the recommendation diversity metric indicating a degree of diversity of contents recommended to a same user, or determining a recommendation relevance metric based on a similarity between each content feature of the respective content features and each user feature of the respective user features.

In some embodiments, the recommendation system is configured to recommend top k objects from the plurality of objects to a user, and the method further comprises: in accordance with a determination that the diversity metric is below a diversity threshold, decreasing a value of k or presenting an indication to decrease the value of k.

In some embodiments, the recommendation system is configured to filter, for a target user, objects having similarities with the target user below a similarity threshold, and the method further comprises: in accordance with a determination that the diversity metric is below a diversity threshold, increasing a value of the similarity threshold or presenting an indication to increase the value of the similarity threshold.

In some embodiments, the recommendation system is configured to perform recommendation by applying a diversity boosting factor to a diversity reward, and the method further comprises: in accordance with a determination that the diversity metric is below a diversity threshold, decreasing the diversity boosting factor or presenting an indication to decrease the diversity boosting factor.

In some embodiments, the method 200 further comprises: in accordance with a determination that the diversity metric is below a diversity threshold, adjusting feature dimensions of each user feature by increasing a ratio of fixed value dimensions to variable value dimensions.

In some embodiments, generating state features of the recommendation system at the first time comprises: generating, for a given user of the plurality of users, a user feature of the given user based on information about the given user, to obtain the respective user features of the plurality of users, or generating, for a given object of the plurality of objects, a content feature of the given object based on information about the given object, to obtain the respective content features of the plurality of objects.

In some embodiments, generating state features of the recommendation system at the first time comprises: updating, for a given user of the plurality of users, a user feature of the given user at a second time based on objects recommended to the given user at the second time, so as to obtain the respective user features of the plurality of users, the second time is previous to the first time, or updating, for a given object of the plurality of objects, a content feature of the given object at the second time based on users to which the given object is recommended, so as to obtain the respective content features of the plurality of objects.

In some implementations of the present disclosure, there is provided an electronic device, comprising a computer processor coupled to a computer-readable memory unit, the memory unit comprising instructions that when executed by the computer processor implements a method of recommendation diversity evaluation. The method comprises: determining a plurality of objects to be recommended in a recommendation system at a first time and a plurality of users to which one or more objects of the plurality of objects is to be recommended at the first time, an object comprising a content item or a content creator; generating state features of the recommendation system at the first time, the state features comprising at least one of respective content features of the plurality of objects or respective user features of the plurality of users; and determining a diversity metric of the recommendation system at the first time based on the state features, the diversity metric indicating a diversity of the recommendation system in user preferences and content creation.

In some embodiments, determining a diversity metric of the recommendation system at the first time based on at least one of the respective content features or the respective user features comprises: determining a polarization metric based on a similarity between each pair of content features of the respective content features, the polarization metric indicating a degree of the recommendation system approaching a polarized recommendation state.

In some embodiments, the polarized recommendation state comprises at least one of: a consensus state in which objects in the recommendation system are preferred by all users of the recommendation system, or a bi-polarization state in which objects and users in the recommendation system are divided into two opposite groups with objects in a first group being preferred by users in the first group and objects in a second group being preferred by users in the second group.

In some embodiments, determining a diversity metric of the recommendation system at the first time based on at least one of the respective content features or the respective user features further comprises at least one of: determining a creation diversity metric based on a difference between each pair of content features of the respective content features, the creation diversity metric indicating a degree of diversity in content creation, determining a recommendation diversity metric based on a difference between each pair of content features recommended to a user of the plurality of users, the recommendation diversity metric indicating a degree of diversity of contents recommended to a same user, or determining a recommendation relevance metric based on a similarity between each content feature of the respective content features and each user feature of the respective user features.

In some embodiments, the recommendation system is configured to recommend top k objects from the plurality of objects to a user, and the method further comprises: in accordance with a determination that the diversity metric is below a diversity threshold, decreasing a value of k or presenting an indication to decrease the value of k.

In some embodiments, the recommendation system is configured to filter, for a target user, objects having similarities with the target user below a similarity threshold, and the method further comprises: in accordance with a determination that the diversity metric is below a diversity threshold, increasing a value of the similarity threshold or presenting an indication to increase the value of the similarity threshold.

In some embodiments, the recommendation system is configured to perform recommendation by applying a diversity boosting factor to a diversity reward, and the method further comprises: in accordance with a determination that the diversity metric is below a diversity threshold, decreasing the diversity boosting factor or presenting an indication to decrease the diversity boosting factor.

In some embodiments, the method 200 further comprises: in accordance with a determination that the diversity metric is below a diversity threshold, adjusting feature dimensions of each user feature by increasing a ratio of fixed value dimensions to variable value dimensions.

In some embodiments, generating state features of the recommendation system at the first time comprises: generating, for a given user of the plurality of users, a user feature of the given user based on information about the given user, to obtain the respective user features of the plurality of users, or generating, for a given object of the plurality of objects, a content feature of the given object based on information about the given object, to obtain the respective content features of the plurality of objects.

In some embodiments, generating state features of the recommendation system at the first time comprises: updating, for a given user of the plurality of users, a user feature of the given user at a second time based on objects recommended to the given user at the second time, so as to obtain the respective user features of the plurality of users, the second time is previous to the first time, or updating, for a given object of the plurality of objects, a content feature of the given object at the second time based on users to which the given object is recommended, so as to obtain the respective content features of the plurality of objects.

In some embodiments of the present disclosure, there is provided a non-transitory computer program product, the non-transitory computer program product comprising a computer readable storage medium having program instructions embodied therewith, the program instructions executable by an electronic device to cause the electronic device to perform a method of recommendation diversity evaluation. The method comprises: determining a plurality of objects to be recommended in a recommendation system at a first time and a plurality of users to which one or more objects of the plurality of objects is to be recommended at the first time, an object comprising a content item or a content creator; generating state features of the recommendation system at the first time, the state features comprising at least one of respective content features of the plurality of objects or respective user features of the plurality of users; and determining a diversity metric of the recommendation system at the first time based on the state features, the diversity metric indicating a diversity of the recommendation system in user preferences and content creation.

FIG. 4 illustrates a block diagram of an electronic device 400 in which various embodiments of the present disclosure can be implemented. It would be appreciated that the electronic device 400 shown in FIG. 4 is merely for purpose of illustration, without suggesting any limitation to the functions and scopes of the present disclosure in any manner. The electronic device 400 may be used to implement the above method 200. As shown in FIG. 4, the electronic device 400 may be a general-purpose electronic device. The electronic device 400 may at least comprise one or more processors or processing units 410, a memory 420, a storage unit 430, one or more communication units 440, one or more input devices 450, and one or more output devices 460.

The processing unit 410 may be a physical or virtual processor and can implement various processes based on programs 425 stored in the memory 420. In a multi-processor system, multiple processing units execute computer executable instructions in parallel so as to improve the parallel processing capability of the electronic device 400. The processing unit 410 may also be referred to as a central processing unit (CPU), a microprocessor, a controller, or a microcontroller.

The electronic device 400 typically includes various computer storage medium. Such medium can be any medium accessible by the electronic device 400, including, but not limited to, volatile and non-volatile medium, or detachable and non-detachable medium. The memory 420 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 430 may be any detachable or non-detachable medium and may include a machine-readable medium such as a memory, flash memory drive, magnetic disk, or another other media, which can be used for storing information and/or data and can be accessed in the electronic device 400.

The electronic device 400 may further include additional detachable/non-detachable, volatile/non-volatile memory medium. Although not shown in FIG. 4, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 440 communicates with a further electronic device via the communication medium. In addition, the functions of the components in the electronic device 400 can be implemented by a single computing cluster or multiple computing machines that can communicate via communication connections. Therefore, the electronic device 400 can operate in a networked environment using a logical connection with one or more other servers, networked personal computers (PCs) or further general network nodes.

The input device 450 may be one or more of a variety of input devices, such as a mouse, keyboard, tracking ball, voice-input device, and the like. The output device 460 may be one or more of a variety of output devices, such as a display, loudspeaker, printer, and the like. By means of the communication unit 440, the electronic device 400 can further communicate with one or more external devices (not shown) such as the storage devices and display device, with one or more devices enabling the user to interact with the electronic device 400, or any devices (such as a network card, a modem, and the like) enabling the electronic device 400 to communicate with one or more other electronic devices, if required. Such communication can be performed via input/output (I/O) interfaces (not shown).

In some embodiments, instead of being integrated in a single device, some, or all components of the electronic device 400 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The functionalities described herein can be performed, at least in part, by one or more hardware logic components. For example, and without limitation, illustrative types of hardware logic components that can be used include Field-Programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

Program code for carrying out the methods of the subject matter described herein may be written in any combination of one or more programming languages. The program code may be provided to a processor or controller of a general-purpose computer, special purpose computer, or other programmable data processing apparatus such that the program code, when executed by the processor or controller, causes the functions/operations specified in the flowcharts and/or block diagrams to be implemented. The program code may be executed entirely or partly on a machine, executed as a stand-alone software package partly on the machine, partly on a remote machine, or entirely on the remote machine or server.

In the context of this disclosure, a machine-readable medium may be any tangible medium that may contain or store a program for use by or in connection with an instruction execution system, apparatus, or device. The machine-readable medium may be a machine-readable signal medium or a machine-readable storage medium. A machine-readable medium may include but not limited to an electronic, magnetic, optical, electromagnetic, infrared, or semiconductor system, apparatus, or device, or any suitable combination of the foregoing. More specific examples of the machine-readable storage medium would include an electrical connection having one or more wires, a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are illustrated in a particular order, this should not be understood as requiring that such operations are performed in the particular order shown or in sequential order, or that all illustrated operations are performed to achieve the desired results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single implementation. Rather, various features described in a single implementation may also be implemented in multiple embodiments separately or in any suitable sub-combination.

Although the subject matter has been described in language specific to structural features and/or methodological acts, it is to be understood that the subject matter specified in the appended claims is not necessarily limited to the specific features or acts described above. Rather, the specific features and acts described above are disclosed as example forms of implementing the claims.

From the foregoing, it will be appreciated that specific embodiments of the presently disclosed technology have been described herein for purposes of illustration, but that various modifications may be made without deviating from the scope of the disclosure. Accordingly, the presently disclosed technology is not limited except as by the appended claims.

Embodiments of the subject matter and the functional operations described in the present disclosure can be implemented in various systems, digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media, and memory devices, including by way of example semiconductor memory devices, e.g., EPROM, EEPROM, and flash memory devices. The processor and the memory can be supplemented by, or incorporated in, special purpose logic circuitry.

It is intended that the specification, together with the drawings, be considered exemplary only, where exemplary means an example. As used herein, the use of “or” is intended to include “and/or”, unless the context clearly indicates otherwise.

While the present disclosure contains many specifics, these should not be construed as limitations on the scope of any disclosure or of what may be claimed, but rather as descriptions of features that may be specific to particular embodiments of particular disclosures. Certain features that are described in the present disclosure in the context of separate embodiments can also be implemented in combination in a single implementation. Conversely, various features that are described in the context of a single implementation can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are illustrated in the drawings in a particular order, this should not be understood as requiring that such operations be performed in the particular order shown or in sequential order, or that all illustrated operations be performed, to achieve desirable results. Moreover, the separation of various system components in the embodiments described in the present disclosure should not be understood as requiring such separation in all embodiments. Only a few embodiments and examples are described and other embodiments, enhancements and variations can be made based on what is described and illustrated in the present disclosure.

What is claimed is:

1. A method of recommendation diversity evaluation, comprising:
determining a plurality of objects to be recommended in a recommendation system at a first time and a plurality of users to which one or more objects of the plurality of objects is to be recommended at the first time, an object comprising a content item or a content creator;
generating state features of the recommendation system at the first time, the state features comprising at least one of respective content features of the plurality of objects or respective user features of the plurality of users; and
determining a diversity metric of the recommendation system at the first time based on the state features, the diversity metric indicating a diversity of the recommendation system in user preferences and content creation.

2. The method of claim 1, wherein determining a diversity metric of the recommendation system at the first time based on at least one of the respective content features or the respective user features comprises:
determining a polarization metric based on a similarity between each pair of content features of the respective content features, the polarization metric indicating a degree of the recommendation system approaching a polarized recommendation state.

3. The method of claim 2, wherein the polarized recommendation state comprises at least one of:
a consensus state in which objects in the recommendation system are preferred by all users of the recommendation system, or
a bi-polarization state in which objects and users in the recommendation system are divided into two opposite groups with objects in a first group being preferred by users in the first group and objects in a second group being preferred by users in the second group.

4. The method of claim 2, wherein determining a diversity metric of the recommendation system at the first time based on at least one of the respective content features or the respective user features further comprises at least one of:
determining a creation diversity metric based on a difference between each pair of content features of the respective content features, the creation diversity metric indicating a degree of diversity in content creation,
determining a recommendation diversity metric based on a difference between each pair of content features recommended to a user of the plurality of users, the recommendation diversity metric indicating a degree of diversity of contents recommended to a same user, or
determining a recommendation relevance metric based on a similarity between each content feature of the respective content features and each user feature of the respective user features.

5. The method of claim 1, wherein the recommendation system is configured to recommend top k objects from the plurality of objects to a user, and the method further comprises:
in accordance with a determination that the diversity metric is below a diversity threshold, decreasing a value of k or presenting an indication to decrease the value of k.

6. The method of claim 1, wherein the recommendation system is configured to filter, for a target user, objects having similarities with the target user below a similarity threshold, and the method further comprises:
in accordance with a determination that the diversity metric is below a diversity threshold, increasing a value of the similarity threshold or presenting an indication to increase the value of the similarity threshold.

7. The method of claim 1, wherein the recommendation system is configured to perform recommendation by applying a diversity boosting factor to a diversity reward, and the method further comprises:
in accordance with a determination that the diversity metric is below a diversity threshold, decreasing the diversity boosting factor or presenting an indication to decrease the diversity boosting factor.

8. The method of claim 1, further comprising:
in accordance with a determination that the diversity metric is below a diversity threshold, adjusting feature dimensions of each user feature by increasing a ratio of fixed value dimensions to variable value dimensions.

9. The method of claim 1, wherein generating state features of the recommendation system at the first time comprises:
generating, for a given user of the plurality of users, a user feature of the given user based on information about the given user, to obtain the respective user features of the plurality of users, or
generating, for a given object of the plurality of objects, a content feature of the given object based on information about the given object, to obtain the respective content features of the plurality of objects.

10. The method of claim 1, wherein generating state features of the recommendation system at the first time comprises:
updating, for a given user of the plurality of users, a user feature of the given user at a second time based on objects recommended to the given user at the second time, so as to obtain the respective user features of the plurality of users, the second time is previous to the first time, or
updating, for a given object of the plurality of objects, a content feature of the given object at the second time based on users to which the given object is recommended, so as to obtain the respective content features of the plurality of objects.

11. An electronic device, comprising a computer processor coupled to a computer-readable memory unit, the memory unit comprising instructions that when executed by the computer processor implements a method of recommendation diversity evaluation, the method comprising:
determining a plurality of objects to be recommended in a recommendation system at a first time and a plurality of users to which one or more objects of the plurality of objects is to be recommended at the first time, an object comprising a content item or a content creator;
generating state features of the recommendation system at the first time, the state features comprising at least one of respective content features of the plurality of objects or respective user features of the plurality of users; and
determining a diversity metric of the recommendation system at the first time based on the state features, the diversity metric indicating a diversity of the recommendation system in user preferences and content creation.

12. The device of claim 11, wherein determining a diversity metric of the recommendation system at the first time based on at least one of the respective content features or the respective user features comprises:
determining a polarization metric based on a similarity between each pair of content features of the respective content features, the polarization metric indicating a degree of the recommendation system approaching a polarized recommendation state.

13. The device of claim 12, wherein the polarized recommendation state comprises at least one of:
a consensus state in which objects in the recommendation system are preferred by all users of the recommendation system, or
a bi-polarization state in which objects and users in the recommendation system are divided into two opposite groups with objects in a first group being preferred by users in the first group and objects in a second group being preferred by users in the second group.

14. The device of claim 12, wherein determining a diversity metric of the recommendation system at the first time based on at least one of the respective content features or the respective user features further comprises at least one of:
determining a creation diversity metric based on a difference between each pair of content features of the respective content features, the creation diversity metric indicating a degree of diversity in content creation,
determining a recommendation diversity metric based on a difference between each pair of content features recommended to a user of the plurality of users, the recommendation diversity metric indicating a degree of diversity of contents recommended to a same user, or
determining a recommendation relevance metric based on a similarity between each content feature of the respective content features and each user feature of the respective user features.

15. The device of claim 11, wherein the recommendation system is configured to recommend top k objects from the plurality of objects to a user, and the method further comprises:
in accordance with a determination that the diversity metric is below a diversity threshold, decreasing a value of k or presenting an indication to decrease the value of k.

16. The device of claim 11, wherein the recommendation system is configured to filter, for a target user, objects having similarities with the target user below a similarity threshold, and the method further comprises:
in accordance with a determination that the diversity metric is below a diversity threshold, increasing a value of the similarity threshold or presenting an indication to increase the value of the similarity threshold.

17. The device of claim 11, wherein the recommendation system is configured to perform recommendation by applying a diversity boosting factor to a diversity reward, and the method further comprises:
in accordance with a determination that the diversity metric is below a diversity threshold, decreasing the diversity boosting factor or presenting an indication to decrease the diversity boosting factor.

18. The device of claim 11, the method further comprising:
in accordance with a determination that the diversity metric is below a diversity threshold, adjusting feature dimensions of each user feature by increasing a ratio of fixed value dimensions to variable value dimensions.

19. The device of claim 11, wherein generating state features of the recommendation system at the first time comprises:
generating, for a given user of the plurality of users, a user feature of the given user based on information about the given user, to obtain the respective user features of the plurality of users, or
generating, for a given object of the plurality of objects, a content feature of the given object based on information about the given object, to obtain the respective content features of the plurality of objects.

20. A computer program product, the computer program product comprising a non-transitory computer readable storage medium having program instructions embodied therewith, the program instructions executable by an electronic device to cause the electronic device to perform a method of recommendation diversity evaluation, the method comprising:
determining a plurality of objects to be recommended in a recommendation system at a first time and a plurality of users to which one or more objects of the plurality of objects is to be recommended at the first time, an object comprising a content item or a content creator;
generating state features of the recommendation system at the first time, the state features comprising at least one of respective content features of the plurality of objects or respective user features of the plurality of users; and
determining a diversity metric of the recommendation system at the first time based on the state features, the diversity metric indicating a diversity of the recommendation system in user preferences and content creation.
